(19) United States
(12) Patent Application Publication
(10) Pub. No.: US 2026/0019768 A1
(43) Pub. Date: Jan. 15, 2026

(54) AUDIO RENDERER FOR MODELING AUDITORY POSITION LAG AND METHOD OF OPERATING THE SAME

(71) Applicant: Electronics and Telecommunications Research Institute, Daejeon (KR)

(72) Inventors: Dae Young Jang, Daejeon (KR); Kyeongok Kang, Daejeon (KR); Jae-hyoun Yoo, Daejeon (KR); Yong Ju Lee, Daejeon (KR)

(73) Assignee: Electronics and Telecommunications Research Institute, Daejeon (KR)

(21) Appl. No.: 19/263,032

(22) Filed: Jul. 8, 2025

(30) Foreign Application Priority Data
Jul. 9, 2024 (KR) 10-2024-0090176
Jun. 11, 2025 (KR) 10-2025-0076335

(51) Int. Cl. H04S 7/00

(52) U.S. Cl. CPC H04S 7/303; H04S 7/305; H04S 2400/11; H04S 2400/13

(57) ABSTRACT

An audio renderer for modeling an auditory position lag and a method operating the same are provided. The method includes determining a distance between a position of an audio object and a listener, determining a time delay required for sound of the audio object to cover the distance, based on the distance, modifying the position of the audio object based on the time delay, and modeling an auditory position lag of the audio object based on the modified position of the audio object.

### CROSS-REFERENCE TO RELATED APPLICATION

This application claims the benefit of Korean Patent Application No. 10-2024-0090176 filed on Jul. 9, 2024, and Korean Patent Application No. 10-2025-0076335 filed on Jun. 11, 2025, in the Korean Intellectual Property Office, the entire disclosures of which are incorporated herein by reference for all purposes.

### BACKGROUND

### 1. Field of the Invention

The following disclosure relates to an audio renderer for modeling an auditory position lag and a method of operating the same.

### 2. Description of the Related Art

An audio service has evolved from mono and stereo services to a multichannel service, such as 5.1, 7.1, 9.1, 11.1, 10.2, 13.1, 15.1, and 22.2 channels. Unlike a conventional channel-based audio service, an object-based audio service that regards a single audio source as an object has been developed. The object-based audio service may store, transmit, and play an object audio signal and information related to object audio (e.g., the position of the object audio and the size of the object audio).

The information required to render an audio signal may be a relative angle and a distance between an audio object and a listener, and the audio signal may be rendered by additionally using acoustic spatial information. This is because the acoustic spatial information enables better realization of acoustic transmission characteristics based on a space. Realizing the acoustic transmission characteristics in detail by using the acoustic transmission characteristics and rendering an object-based audio signal may require a significantly complex operation. A method of rendering an object-based audio signal by dividing the object-based audio signal into direct sound, early reflection, and late reverberation is proposed to simply realize the acoustic transmission characteristics based on a space.

The above description is information the inventor(s) acquired during the course of conceiving the present disclosure, or already possessed at the time, and is not necessarily art publicly not known before the present application was filed.

### SUMMARY

Various embodiments may model an auditory position lag of an audio object according a distance between a position of the audio object and a listener.

Various embodiments may determine an auditory position of an audio object according to a distance between a visual position of the audio object and a listener and may render a sound source of the audio object based on the determined auditory position.

Various embodiments may determine whether to apply an auditory position lag of an audio object to the audio object depending on the situation.

Other goals and advantages of the present disclosure may be understood by the following description and will become more apparent by the embodiments of the present disclosure. In addition, it will be apparent that the goals and advantages of the present disclosure may be realized by the means and combinations thereof recited in the claims.

According to an aspect, there is provided a method of operating an audio renderer, including determining a distance between a position of an audio object and a listener, determining a time delay required for sound of the audio object to cover the distance, based on the distance, modifying the position of the audio object based on the time delay, and modeling an auditory position lag of the audio object based on the modified position of the audio object.

The modifying of the position of the audio object includes modifying the position of the audio object based on the time delay and a previous position of the audio object.

The modeling of the auditory position lag includes determining whether to apply the auditory position lag to the audio object, according to a predetermined flag for the audio object.

The modeling of the auditory position lag includes rendering a sound source of the audio object at the modified position of the audio object, according to the auditory position lag.

The modeling of the auditory position lag includes determining a distance gain and a medium absorption gain according to the modified position of the audio object and determining a Doppler effect according to a change in the distance, and rendering the sound source of the audio object, based on the distance gain, the medium absorption gain, and the Doppler effect.

The modeling of the auditory position lag includes skipping modeling for the auditory position lag of the audio object that is apart from the listener by a predetermined distance or more.

The determining of the time delay includes determining the time delay by dividing the distance by a speed of the audio object.

According to an aspect, a method of operating an audio renderer, including determining a distance between a visual position of an audio object and a listener, determining a time delay required for sound of the audio object to cover the distance, based on the distance, determining an auditory position of the audio object, based on the visual position and the time delay, and rendering a sound source of the audio object based on the auditory position.

The determining of the auditory position of the audio object includes determining the auditory position of the audio object, based on the time delay and a previous position of the audio object.

The rendering of the sound source of the audio object includes determining whether to render the sound source of the audio object, according to a predetermined flag for the audio object.

The rendering of the sound source of the audio object includes determining a distance gain and a medium absorption gain according to the auditory position and determining a Doppler effect according to a change in the distance, and rendering the sound source of the audio object, based on the distance gain, the medium absorption gain, and the Doppler effect.

The rendering of the sound source of the audio object includes skipping modeling the sound source of the audio object that is apart from the listener by a predetermined distance or more.

The determining of the time delay includes determining the time delay by dividing the distance by a speed of the audio object.

According to an aspect, an audio renderer includes a processor, and memory storing instructions, wherein the instructions, when executed by the processor, cause the audio renderer to determine a distance between a position of an audio object and a listener, determine a time delay required for sound of the audio object to cover the distance, based on the distance, modify the position of the audio object based on the time delay, and model an auditory position lag of the audio object based on the modified position of the audio object.

The instructions, when executed by the processor, cause the audio renderer to modify the position of the audio object based on the time delay and a previous position of the audio object.

The instructions, when executed by the processor, cause the audio renderer to determine whether to apply the auditory position lag to the audio object, according to a predetermined flag for the audio object.

The instructions, when executed by the processor, cause the audio renderer to render a sound source of the audio object at the modified position of the audio object, according to the auditory position lag.

The instructions, when executed by the processor, cause the audio renderer to determine a distance gain and a medium absorption gain according to the modified position of the audio object and determine a Doppler effect according to a change in the distance, and render the sound source of the audio object, based on the distance gain, the medium absorption gain, and the Doppler effect.

The instructions, when executed by the processor, cause the audio renderer to skip modeling for the auditory position lag of the audio object that is apart from the listener by a predetermined distance or more.

The instructions, when executed by the processor, cause the audio renderer to determine the time delay by dividing the distance by a speed of the audio object.

Various embodiments may realistically render a sound source of an audio object and may improve the realism experienced by a listener by modeling an auditory position lag according to a distance between the audio object and the listener and the speed of the audio object.

Various embodiments may realistically model an audio object that moves at high speed in a virtual reality (VR) environment and the like.

Additional aspects of embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a block diagram of a component overview of an audio renderer according to an embodiment;

FIG. 2 is a diagram illustrating an encoder structure of an audio renderer;

FIG. 3 is a diagram illustrating renderer stages of a renderer pipeline of an audio renderer;

FIG. 4 is a diagram illustrating an audio renderer according to an embodiment;

FIGS. 5 and 6 are flowcharts of a method of operating an audio renderer according to an embodiment;

FIGS. 7 and 8 are diagrams illustrating an operation of modeling an auditory position lag according to an embodiment;

FIG. 9 is a diagram illustrating code for rendering a render item according to an embodiment;

FIGS. 10 and 11 are diagrams illustrating code for modeling an auditory position lag according to an embodiment;

FIG. 12 is a diagram illustrating code for rendering a sound source according to an embodiment;

FIGS. 13 to 15 are diagrams illustrating syntaxes and flags according to an embodiment;

FIG. 16 is a diagram illustrating metadata on a render item according to an embodiment;

FIG. 17 is a diagram illustrating a data structure with respect to a render item according to an embodiment;

FIG. 18 is a diagram illustrating parameters according to an embodiment; and

FIG. 19 is a block diagram of an audio renderer according to an embodiment.

### DETAILED DESCRIPTION

The following detailed structural or functional description is provided as an example only and various alterations and modifications may be made to the embodiments. Accordingly, the embodiments are not construed as limited to the disclosure and should be understood to include all changes, equivalents, and replacements within the idea and the technical scope of the disclosure.

As used herein, “at least one of A and B”, “at least one of A, B, or C,” and the like, each of which may include any one of the items listed together in the corresponding one of the phrases, or all possible combinations thereof. Although terms, such as first, second, and the like are used to describe various components, the components are not limited to the terms. These terms should be used only to distinguish one component from another component. For example, a first component may be referred to as a second component, and similarly, the second component may also be referred to as the first component.

It should be noted that if it is described that one component is “connected”, “coupled”, or “joined” to another component, a third component may be “connected”, “coupled”, and “joined” between the first and second components, although the first component may be directly connected, coupled, or joined to the second component.

As used herein, the singular form is intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which the present disclosure pertains. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

Hereinafter, embodiments will be described in detail with reference to the accompanying drawings. When describing the embodiments with reference to the accompanying drawings, like reference numerals refer to like elements and a repeated description related thereto will be omitted.

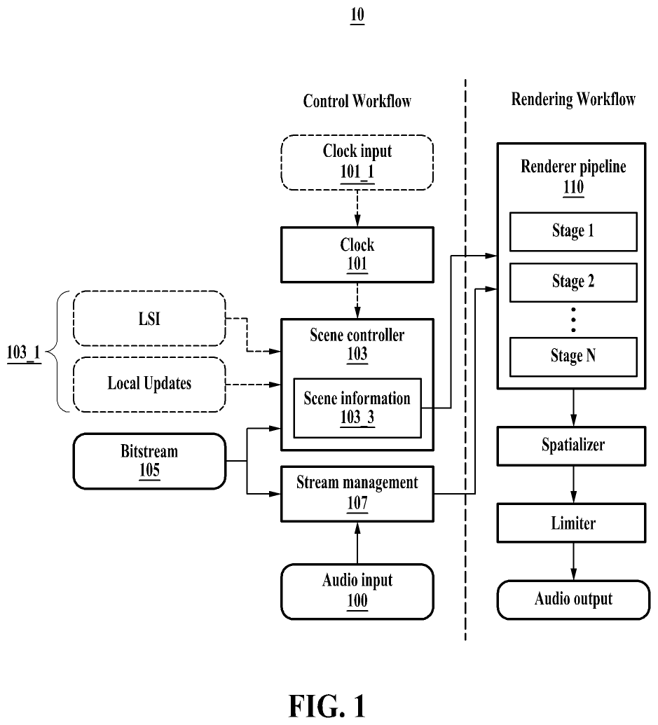

FIG. 1 is a block diagram of a component overview of an audio renderer according to an embodiment.

According to an embodiment, an audio renderer 10 may be a device for rendering a sound source in virtual reality (VR) or augmented reality (AR) and providing the rendered sound source to a listener. For example, the audio renderer 10 may allow the listener to experience virtual sound in a VR or AR simulation through immersive audio playback using a 6 degrees of freedom (DoF) motion of the listener in an audio scene. An audio effect or phenomenon known in real-world acoustics, such as sound localization, distance attenuation, reflection, reverberation, occlusion, diffraction, and the Doppler effect, may be modeled by the audio renderer 10 that is controlled by additionally inputting interactive listener position data and metadata transmitted to a bitstream. In this case, 6DoF may represent spatial navigation (x, y, z) and user head orientation (yaw, pitch, and roll). Herein, for ease of description, a user of the audio renderer 10 may be the listener.

While a VR presentation may provide the user with the feeling that the user is actually present in a virtual world, AR may enrich the real world by allowing the user to seamlessly perceive a virtual element as a part of the real world. The user may interact with a virtual scene or a virtual element, and in response to the interaction, the audio renderer 10 may generate realistic sound that matches the user's experience in the real world. The audio renderer 10 may render a real-time interactive audio presentation while allowing the user to have a 6DoF motion.

The audio renderer 10 may support real-time auralization of complex 6DoF audio scenes in which the user may directly interact with an entity in the scene. For this, a software architecture of the audio renderer 10 may be divided into a plurality of workflows and components. In an embodiment, the audio renderer 10 may support rendering of VR and AR scenes. In the case of VR and AR scenes, rendering metadata and audio scene information may be obtained from a bitstream.

In an embodiment, the audio renderer 10 may perform a control workflow and a rendering workflow. For example, the audio renderer 10 may include a control unit and a rendering unit. In the control workflow, the control unit may include a clock 101, a scene controller 103, and a stream manager 107. In the rendering workflow, the rendering unit may include a renderer pipeline 110, a spatializer, and a limiter. The audio renderer 10 may render an audio object through the control workflow and the rendering workflow. In addition, the audio renderer 10 may interface with an external system and components through the control unit.

The control workflow may be an entry point of the audio renderer 10 and may handle interfaces with an external system and components. The main functionality of the control workflow may be embedded in a scene controller component, which coordinates all entity states in a 6DoF scene and implements an interactive interface of the audio renderer 10. The scene controller 103 may support external updates of modifiable properties of scene objects and may complete information about the bitstream by receiving listener space information (LSI). In addition, the scene controller 103 may track time-dependent or location-dependent properties (e.g., interpolated locations or listener proximity conditions) of the scene objects.

A scene state used by the scene controller 103 may reflect a current state of the scene objects including audio elements, transforms/anchors, and geometry. Other components of the audio renderer 10 may reflect a change in the scene state. Before rendering starts, all objects of the entire scene may be generated, and metadata of the objects may be updated to a state that reflects a desired scene configuration at the start of playback. In an embodiment, the scene controller 103 may process a change in all internal or external scene information 103_3. An input to the scene controller 103 may be information (e.g., the LSI, a location of the listener, and dynamic update information 103_1) input by an external interface of the audio renderer and information (e.g., scene update information) transmitted from a bitstream 105. The scene controller 103 may include a scene information module. The scene information module may update a current state of metadata (e.g., an acoustic element and a physical object) related to 6DoF rendering of a scene. The scene information module may output the current internal or external scene information 103_3 to the renderer pipeline 110.

The stream manager 107 may provide an integrated interface to allow the components of the audio renderer 10 to access an audio stream associated with an audio element of a scene state as well as a basic audio playback variable, such as an audio sample frequency and an audio frame length. For example, the stream manager 107 may provide an interface to input a sound signal (e.g., an audio input 100) of an acoustic element of the scene information module. The audio stream may be input to the audio renderer 10 as a pulse code modulation (PCM) float sample. A source of the audio stream may be, for example, a decoded audio stream or locally captured audio. The audio input 100 may be a sound source signal, a local sound source, or a remote sound source that are encoded or decoded in advance. The stream manager 107 may output the sound signal to the renderer pipeline 110. The renderer pipeline 110 may render the sound signal input from the stream manager 107 by using the current scene information 103_3. The renderer pipeline 110 may include renderer stages for signal processing and renderer parameter processing of a sound signal (e.g., a render item RI) to be rendered.

The clock 101 may provide an interface to the components of the audio renderer 10 to obtain a current scene time in seconds. A clock input 101_1 may be, for example, a synchronization signal of other subsystems or an internal clock of the audio renderer 10. The clock input to the scene controller 103 may not be related to audio synchronization. The clock 101 may output current time information of the scene to the scene controller 103.

The rendering workflow may generate a PCM float audio output signal. The rendering workflow may be separated from the control workflow, and in the rendering workflow, a scene state (for transmitting a change in the 6DoF scene) and the stream manager may be accessed for communication between the two workflows.

The renderer pipeline 110 may auralize an input audio stream provided by the stream manager 107 based on the current scene state. Rendering may be organized in a sequential pipeline, and each stage of the renderer pipeline 110 may implement an independent perceptual effect and may use processing of previous and subsequent operations. Each stage of the renderer pipeline 110 may be instantiate in an initialization process of the audio renderer 10 and may be processed in a predetermined order.

The spatializer may be positioned after the renderer pipeline 110 and may auralize outputs of the stages of the renderer pipeline 110 to a single output audio stream suitable for a desired playback method (e.g., binaural or adaptive loudspeaker rendering).

The limiter may provide clipping protection to an auralized multi-channel output signal.

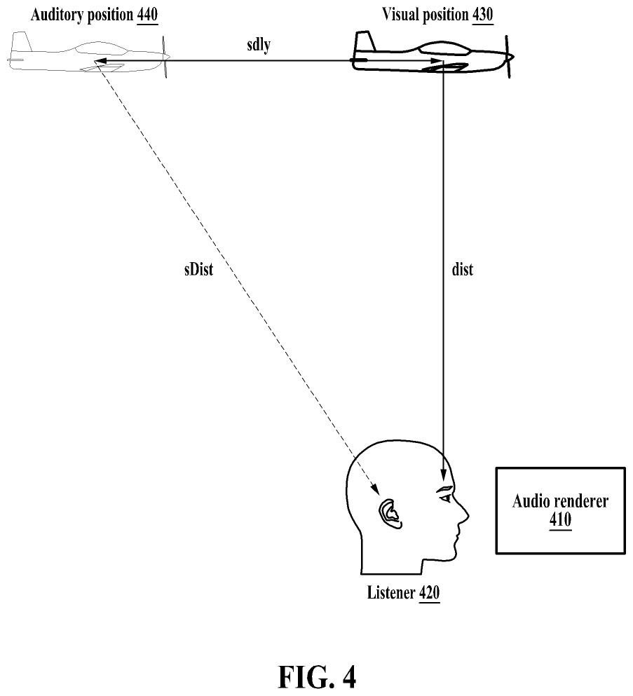

According to an embodiment, when rendering an audio object and a sound source of the audio object, the audio renderer 10 may model an auditory position lag of the audio object by considering the distance between a position of the audio object and a listener. For example, based on the distance between the position of the audio object and the listener, the audio renderer 10 may determine a time delay required for the sound of the audio object to cover the distance and may model an auditory position lag by modifying the position of the audio object, based on the determined time delay. In an embodiment, the audio renderer 10 may determine an auditory position, based on a visual position of the audio object and the time delay and may render a sound source of the audio object based on the determined auditory position. The process of modeling the auditory position lag by the audio renderer 10 is further described below with reference to FIGS. 4 to 19.

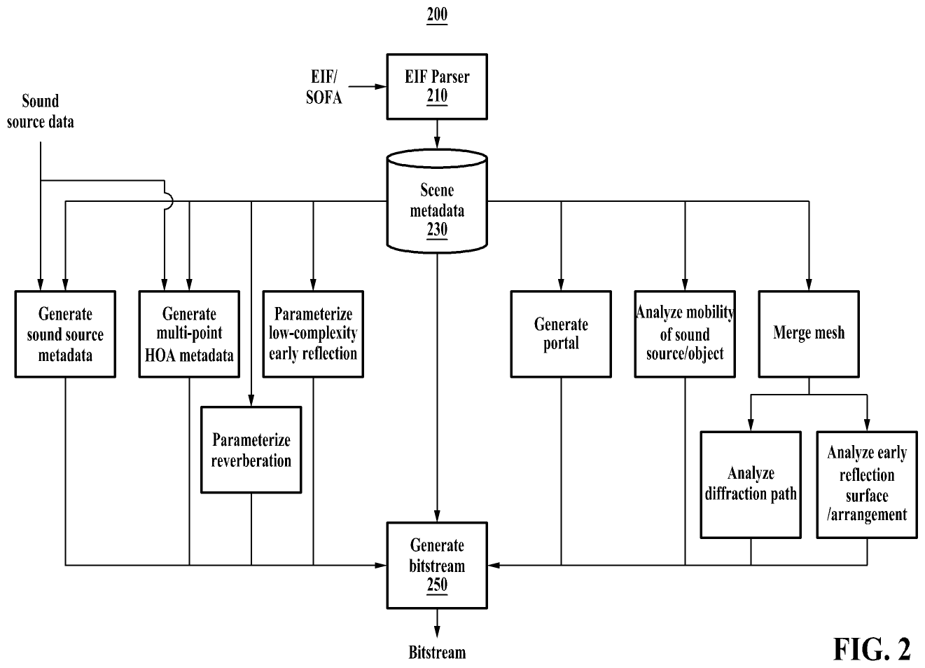

FIG. 2 is a diagram illustrating an encoder structure of an audio renderer.

Referring to FIG. 2, the audio renderer may include an encoder 200. The encoder 200 may include an encoder input format (EIF) parser module 210, a scene metadata module 230, and a bitstream generation module 250.

The EIF parser module 210 may receive directivity information of an EIF and/or a spatial oriented format for audio (SOFA) format, which are a common input format of the encoder 200, as an input. The EIF parser module 210 may extract elements (e.g., spatial geometric structure information, sound source information (e.g., the position, shape, and directivity of the sound source), material and spatial acoustic characteristic information, and update information (e.g., motion information)) constituting scene information of content by analyzing information of the EIF and/or SOFA format.

In an embodiment, the metadata of EIF may include data for the audio renderer to render the auditory position lag. For example, the metadata of EIF may include at least one of a position of the audio object, a previous position, a moving path, and a flag whether to apply an auditory position lag.

The scene metadata module 230 may include a sound source metadata generation module, a multi-point higher order ambisonics (HOA) metadata generation module, a reverberation parameterization module, a low-complexity early reflection parameterization module, a portal generation module, a source/object mobility analysis module, a mesh merge module, a diffraction path analysis module, and an initial reflective surface and array analysis module.

The bitstream generation module 250 may receive metadata generated by each module of the encoder 200 and directivity information of an SOFA file and may generate a bitstream by quantizing and multiplexing the metadata and the directivity information of the SOFA file.

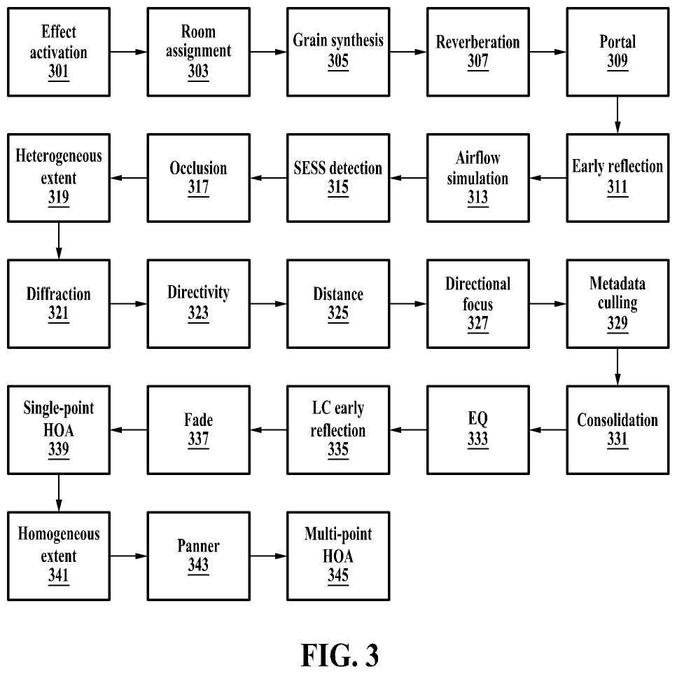

FIG. 3 is a diagram illustrating renderer stages of a renderer pipeline of an audio renderer.

Referring to FIG. 3, renderer stages of an audio renderer to render an audio object are illustrated as an example. Each renderer stage may be executed in a predetermined order. For example, each renderer stage may be executed in the order shown in FIG. 3, but the embodiment is not limited thereto. In each renderer stage, render items (e.g., an audio object) may be selectively deactivated or activated. Each renderer stage may render an activated render item. Hereinafter, each renderer stage is described.

An effect activator stage 301 may be a stage for managing activation and deactivation of render items that are associated with sound effect playback. Scene objects may be activated or deactivated in a scene state during runtime.

A room assigning stage 303 may be a stage for applying metadata of acoustic environmental information about a room that a listener enters to each render item when the listener enters the room including the acoustic environmental information. Herein, for ease of description, the room assigning stage 303 may be referred to as an acoustic environment assigning stage. The room assigning stage 303 may update each render item and metadata of the listener at each update stage and may reflect a current scene configuration based on acoustic environments defined in the scene.

A granular synthesis stage 305 may be a method of rendering procedural audio and may be a stage in which sound evolves in a controlled scheme by using a real-time input. The granular synthesis may be based on an original recording divided into small pieces, for example, grains. The granular synthesis stage 305 may operate by chaining grains at the rendering time, and a grain to be used may be controlled by a real-time user input, changing a virtual scene state, or a predefined trajectory.

A reverberation stage 307 may be a stage for rendering diffuse late reverberation of each acoustic environment. For example, the reverberation stage 307 may be a stage for generating reverberation according to the acoustic environmental information of a current space (e.g., the room including the acoustic environmental information). The reverberation stage 307 may be a stage for receiving a reverberation parameter from a bitstream (e.g., the bitstream 105 of FIG. 1), attenuating a feedback delay network (FDN) reverberator, and initializing a delay parameter.

A portal stage 309 may be a stage for managing activation and deactivation of two source types associated with a portal. In this case, the portal may be an abstract concept that models transmission of sound from one space to another via a geometrically defined open portion. Firstly, in the portal stage 309, the audio renderer may set a reverberation extension sound source such that the reverberation is heard via an acoustic opening (e.g., the portal) in an external acoustic environment and may manage signal mixing that is played from the reverberation extension sound source. Secondly, in the portal stage 309, the audio renderer may manage coupling sources that render sources on an opposite side of the portal with material and may simulate vibration occurring in a door or a window to cause the vibration to become an extended source.

An early reflection stage 311 may be a stage for computing specular reflection from a reflecting surface by using transmitted geometry data. In the early reflection stage 311, an image source model may be used to identify the visibility of a potential propagation path from a sound source to the listener.

An airflow simulation stage 313 may be a stage for simulating sound perceived by the listener when air passes an ear of the user. The sound that the listener hears may vary depending on the speed of the airflow and a direction of the listener.

A spatially extended sound source (SESS) detecting stage 315 may be an auxiliary stage to render the SESS.

An occlusion stage 317 may be a stage for providing occlusion information about a direct path (e.g., a gaze) from a sound source to the listener. When the path is occluded by an object that is acoustically opaque or partially transparent, geometry/mesh information along the gaze may be updated in a dedicated data structure.

A heterogeneous extent rendering stage 319 may be a stage for rendering audio elements that are spatially heterogeneous. The spatially heterogeneous audio elements may be audio elements having a source signal having an extended size and two or more audio channels. The audio elements may include object sources having two or more source channels and HOA sources having an extended size. Rendering may appropriately represent the audio elements at a listening position in or out of a range including both width and height information using the provided extended size information.

A diffraction stage 321 may be a stage for generating information required to generate a diffracted sound source transmitted to the listener from a sound source that is blocked by an obstacle. In the diffraction stage 321, pre-processed geometry data of a bitstream including an edge, a path, and voxel data may be used. For a fixed sound source, a pre-computed diffraction path may be used to generate the information. For a moving sound source, a diffraction path computed from a potential diffraction edge may be used to generate the information.

A directivity stage 323 may be a stage for auralizing a directivity property of an audio element. The directivity stage 323 may include coding of directivity data and rendering the directivity data.

A distance stage 325 may be a stage for rendering independent perceptual effects related to transmission of sound through the air, for example, a propagation delay, a distance gain, and medium absorption. The distance stage 325 may compute a current distance between each render item (e.g., an audio object) and the listener and may interpolate a distance between calls for an update routine based on a constant velocity model. The propagation delay may be applied to a signal associated with the render item to generate a physically accurate delay and Doppler effect using a variable delay line including subsample interpolation. Smoothing may be applied to a distance used for propagation delay rendering when updating the model velocity to mitigate jitter in updating a location of a head-tracked listener and a location of the render item. The conversion from the distance to propagation delay may be calculated with the speed of sound given by a local configuration parameter. In an embodiment, in the distance stage 325, the audio renderer may model the auditory position lag of the audio object, based on the distance between the position of the audio object and the listener.

In an embodiment, the distance between the location of the listener and the render item may be calculated as a Euclidean distance when a location update is provided. The distance may correspond to a momentary propagation delay reproduced using an interpolated variable delay line. A continuous change in propagation delay may inherently generate a physically accurate Doppler effect. A Doppler pitch shift may be a function of the relative velocity between a sound source and an observer, for example, the derivative of a distance.

A directional focus stage 327 may be a stage for attenuating distracting sound outside a spatial region of interest to improve accessibility. A focus may be radially symmetric with one main lobe region.

A metadata culling stage 329 may be a stage for saving computations that may occur in a subsequent stage by deactivating a render item that is inaudible due to a very low gain or an equalizer (EQ) (e.g., strong distance attenuation or occlusion). In addition, a reflection render item that is perceived as a part of a parent primary render item may be deactivated and culled due to a precedence effect.

A consolidation stage 331 may be a stage for consolidating render items having similar localization properties to reduce the total number of render items of the renderer pipeline or computational complexity. A render item of which the difference in a perceptual localization property is less than or equal to a given threshold may be identified by a psychoacoustic model. A group of render items within the threshold may be selected via a computationally efficient clustering algorithm, based on the phychoacoustic model. The render items in each group may be consolidated into a common representative render item. For temporal stability, the assignment of render items may be optimized to avoid unnecessarily frequent reassignment, and when the assignment of render items has changed, crossfades may be applied.

An EQ stage 333 may be a stage for applying a frequency-dependent gain to all relevant audio signals after frequency-dependent attenuation is accumulated for acoustic effects (e.g., occlusion, diffraction, reflection, directivity, and medium attenuation) in previous stages.

A low-complexity (LC) early reflection stage 335 may be a stage for applying early reflection to sound. In an indoor acoustic environment, an impulse response may include direct sound, early reflection, and late reverberation. In the LC early reflection stage 335, when the listener and/or the sound source moves in the environment, the direct sound and all early reflections may dynamically change an individual direction and a distance from the listener. In the LC early reflection stage 335, one common reflection pattern may be applied to all default sound sources in the scene.

A fade stage 337 may be a stage for applying fade-in and fade-out ramps to an audio signal before the render items are activated or deactivated. For example, the fade stage 337 may be a stage for reducing, by fade in-out processing, discontinuous distortion that may occur when an activation state of the render item changes or the listener suddenly moves in the space.

A single point HOA stage 339 may be a stage for binaurally rendering a single point HOA source depending on the location and direction of the listener relative to the location of the sound source. For example, the single point HOA stage 339 may be a stage for rendering background sound by the single point HOA source. The single point HOA stage 339 may be a stage for converting a signal in an equivalent spatial domain (ESD) format input from the bitstream into HOA and converting the HOA into a binaural signal via a magnitude least-squares (MagLS) decoder. The single point HOA stage 339 may be a stage for converting input audio into HOA and spatially combining and converting the signal by HOA decoding.

A homogeneous extent stage 341 may be a stage for synthesizing an SESS for headphone playback of an object source of which a predetermined flag (e.g., objectSourceHasExtent) is set to “1”. In this case, the predetermined flag may be a flag indicating whether the object source is spatially extended.

A panner stage 343 may be a stage for panning a sound source to virtual loudspeaker (LS) setup. The panner stage 343 may be a stage for implementing vector-base-amplitude-panning (VBAP) by an additional control function, such as configurable spatial spread.

A multi-point HOA stage 345 may be a stage for providing a 6DoF listening environment to the listener by rendering audio scenes including one or more multichannel signal sets represented by an HOA source. For example, the multi-point HOA stage 345 may be a stage for performing 6DoF rendering on HOA sound sources relative to the location of the listener using information about a spatial metadata frame.

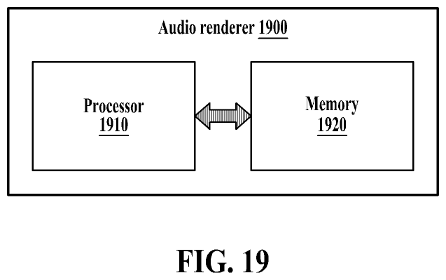

Hereinafter, with reference to FIGS. 4 to 19, an audio renderer for modeling an auditory position lag and an operating method thereof according to an embodiment are described. According to an embodiment, an audio renderer 1900 of FIG. 19 may perform an audio rendering method.

FIG. 4 is a diagram illustrating an audio renderer according to an embodiment.

Referring to FIG. 4, an audio renderer 410 may determine an auditory position 440 of an audio object, based on a distance between a visual position 430 of the audio object and a listener 420. Alternatively, the audio renderer 410 may modify the position of the audio object, based on the distance between the position of the audio object and the listener 420.

When audio objects need to be synchronized with video objects in a VR scene, more precise audio playback may be required. For example, a 6DoF VR application may require to reflect a physical phenomenon by processing a relative position of the audio object according to the position and orientation of the listener. Since the speed of light is faster than the speed of sound, a fast-moving audio object (e.g., an aircraft, a jet, a rocket, and a vehicle) in the real world may have a perceptible difference between the visual position 430 and a position of a sound source of the audio object. In an embodiment, the audio renderer 410 may determine the auditory position 440 of the audio object, based on the visual position 430 of the audio object in VR or AR and may reflect the difference by rendering the sound source of the audio object at the auditory position 440, thus providing more realistic sound source playback to the listener 420. However, in the present disclosure, the audio object may include not only a fast-moving object but also an object that moves in VR or AR regardless of speed.

In FIG. 4, the auditory position 440 of the audio object may be delayed compared to the visual position 430 of the audio object. The listener 420 may see the audio object at the visual position 430 at the moment the listener 420 hears the sound source of the audio object at the auditory position 440. Accordingly, the audio renderer 410 may determine the auditory position 440 of the audio object to be one of previous positions of the moved audio object. A lag of the auditory position 440 may correspond to the time taken to propagate sound by a distance sDist between the auditory position 440 and the listener 420. According to an embodiment, the audio renderer 410 may determine the auditory position 440 of the audio object using a distance dist between the visual position 430 of the audio object and the listener 420.

The audio renderer 410 may determine the visual position 430 of the audio object from a movement trajectory of the audio object. For example, the audio renderer 410 may determine the visual position 430 of the audio object through a function to obtain the movement trajectory of the audio object. For example, the audio renderer 410 may determine the visual position 430 of the audio object at the current time via the movement trajectory of the audio object as Equation 1 below.

$$vp = trajectory -> getLocation ( ct ) \qquad [ Equation 1 ]$$

In this case, vp may denote the visual position 430 of the audio object, trajectory may denote a movement trajectory of the audio object, getLocation may denote a function to determine a position at a corresponding time in the movement trajectory, and ct may denote a current time.

The audio renderer 410 may determine the distance between the audio object and the listener 420, based on the visual position 430 of the audio object. The audio renderer 410 may obtain the position of the listener from head tracking information of a rendering system. For example, the audio renderer 410 may determine the absolute value of a position difference between the visual position 430 of the audio object and the position of the listener 420 to be the distance between the visual position 430 of the audio object and the listener 420 as Equation 2 below.

$$dist = \vert vp - lp \vert \qquad [ Equation 2 ]$$

Based on the distance between the visual position 430 of the audio object and the listener 420, the audio renderer 410 may determine a time delay required for the sound of the audio object to cover the distance. For example, the audio renderer 410 may determine the time delay using a moving speed of the sound as Equation 3 below.

$$sdly = dist / SpeedOfSound \qquad [ Equation 3 ]$$

In this case, sdly may denote a time delay and SpeedOfSound may denote the moving speed of the sound. For example, the moving speed of the sound may be 343 m/s but may vary depending on the embodiment.

The audio renderer 410 may determine the auditory position 440 of the audio object, based on the time delay. The audio renderer 410 may determine the auditory position 440 of the audio object, based on the visual position 430 of the audio object and the time delay. For example, the audio renderer 410 may determine the auditory position 440 of the audio object by subtracting the time delay from the current time as Equation 4 below.

$$ap = trajectory -> getLocation ( ct - sdly ) \qquad [ Equation 4 ]$$

In this case, ap may denote the auditory position 440 of the audio object.

The audio renderer 410 may implement a sound lag by rendering the sound source at the auditory position 440 instead of the visual position 430 of the audio object in a spatializer In addition, when rendering the sound source at the auditory position 440, the audio renderer 410 may determine at least one of a distance gain, medium absorption, and Doppler effect of the sound source according to the auditory position and may render the sound source of the audio object by reflecting the determined distance gain, medium absorption, and Doppler effect. For example, the audio renderer 410 may determine the distance between the auditory position 440 of the audio object and the listener 420 and may determine the distance gain, medium absorption, and Doppler effect of the sound source, based on the determined distance between the auditory position 440 and the listener 420.

$$sDist = \vert ap - lp \vert \qquad [ Equation 5 ]$$

In this case, sDist may denote the distance between the auditory position 440 of the audio object and the listener 420.

For example, the position lag according to the speed of each audio object may be shown in Table 1 below.

TABLE 1

| | | | Distance | | Time delay | | | |
|---|---|---|---|---|---|---|---|---|
| | Speed | | sDist | | sdly | | Localization distance | |
| Aircraft | 250 | [m/sec] | 5,000 | [m] | 15 | [sec] | 3,750 | [m] |
| Jet | 400 | [m/sec] | 100-5,000 | [m] | 0.3-15 | [sec] | 120-6,000 | [m] |
| Rocket | 1,000 | [m/sec] | 5,000 | [m] | 15 | [sec] | 15,000 | [m] |

According to an embodiment, the audio renderer 420 may determine the auditory position 440 of the audio object again using the distance sDist between the determined auditory position 440 of the audio object and the listener 420 and the time delay sdly to more accurately determine the auditory position 440 of the audio object.

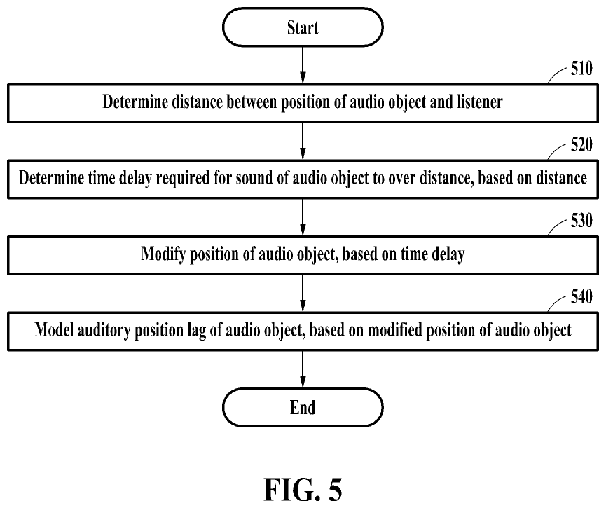

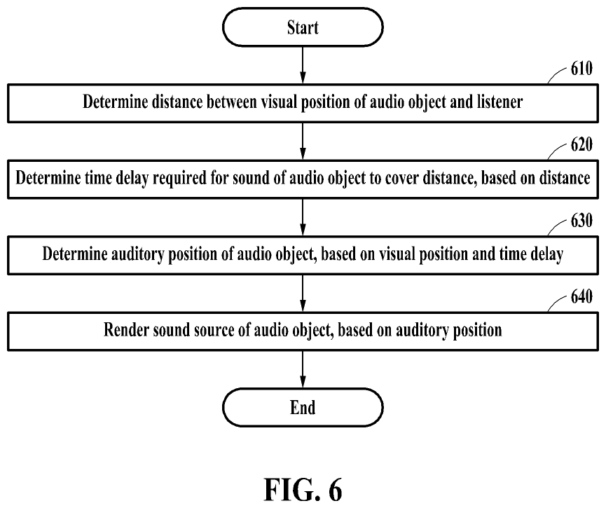

FIGS. 5 and 6 are flowcharts of a method of operating an audio renderer according to an embodiment.

Referring to FIG. 5, in the following embodiments, operations may be performed sequentially but not necessarily. For example, the order of the operations may change, and at least two of the operations may be performed in parallel. Operations 510 to 540 may be performed by at least one component (e.g., a processor, etc.) of an audio renderer.

In operation 510, the audio renderer may determine a distance between a position of an audio object and a listener.

In operation 520, the audio renderer may determine a time delay required for sound of the audio object to cover the distance between the position of the audio object and the listener, based on the distance. The audio renderer may determine a time delay by dividing the distance between the position of the audio object and the listener by the speed of the audio object.

In operation 530, the audio renderer may modify the position of the audio object, based on the time delay. The audio renderer may modify the position of the audio object, based on the time delay and a previous position of the audio object.

In operation 540, the audio renderer may model an auditory position lag of the audio object, based on the modified position of the audio object. The audio renderer may determine whether to apply the auditory position lag to the audio object according to a predetermined flag with respect to the audio object. The audio renderer may render a sound source of the audio object at the modified position of the audio object according to the auditory position lag. The audio renderer may determine a distance gain and a medium absorption gain according to the modified position of the audio object, may determine a Doppler effect according to a change in the distance between the position of the audio object and the listener, and may render the sound source of the audio object, based on the distance gain, the medium absorption gain, and the Doppler effect. The audio renderer may skip modeling for the auditory position lag of the audio object that is apart from the listener by a predetermined distance or more.

Referring to FIG. 6, in the following embodiments, operations may be performed sequentially but not necessarily. For example, the order of the operations may change, and at least two of the operations may be performed in parallel. Operations 610 to 640 may be performed by at least one component (e.g., a processor, etc.) of an audio renderer.

In operation 610, the audio renderer may determine a distance between a visual position of an audio object and a listener.

In operation 620, the audio renderer may determine a time delay required for sound of the audio object to cover the distance between the visual position of the audio object and the listener, based on the distance between the visual position of the audio object and the listener. The audio renderer may determine a time delay by dividing the distance between the visual position of the audio object and the listener by the speed of the audio object.

In operation 630, the audio renderer may determine an auditory position of the audio object, based on the visual position and the time delay. The audio renderer may determine the auditory position of the audio object, based on the time delay and a previous position of the audio object.

In operation 640, the audio renderer may render a sound source of the audio object, based on the auditory position. The audio renderer may determine whether to render the sound source of the audio object according to a predetermined flag with respect to the audio object. The audio renderer may determine a distance gain and a medium absorption gain according to the auditory position, may determine a Doppler effect according to a change in the distance between the visual position of the audio object and the listener, and may render the sound source of the audio object, based on the distance gain, the medium absorption gain, and the Doppler effect. The audio renderer may skip modeling of the sound source of the audio object that is apart from the listener by a predetermined distance or more.

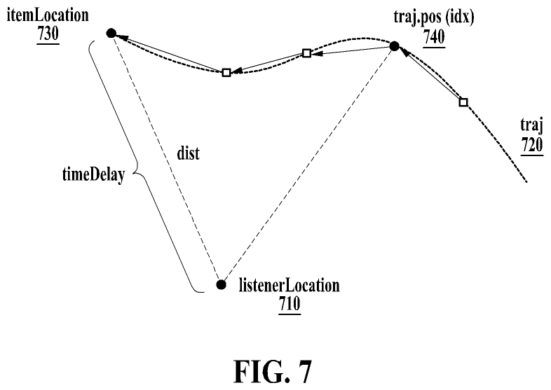

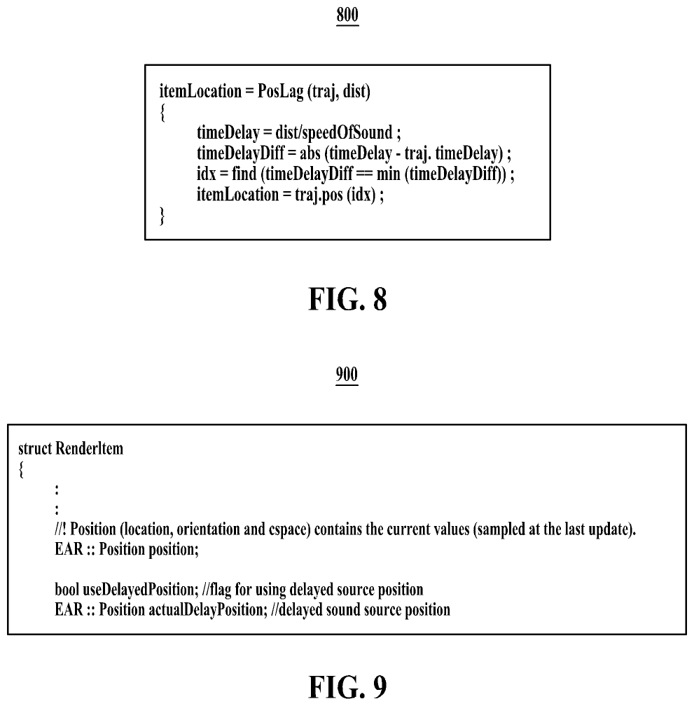

FIGS. 7 and 8 are diagrams illustrating an operation of modeling an auditory position lag according to an embodiment.

Referring to FIG. 7, an audio renderer may model an auditory position lag for a listener 710 by modifying a position 730 of an audio object to a position 740, based on a movement trajectory 720 of the audio object.

According to an embodiment, the audio renderer may determine whether to apply the auditory position lag to the audio object according to a predetermined flag with respect to the audio object. In this case, the predetermined flag may indicate whether the auditory position lag that occurs due to propagation delay modeling of sound delivered to the listener is applied to the audio object. The predetermined flag may be included in a syntax indicating the corresponding audio object. For example, when a value of a predetermined flag “objectSourcePositionLagEnabled” included in a bitstream is a first value (e.g., “TRUE”) (e.g., “objectSourcePositionLagEnabled==TRUE”), the audio renderer may apply the auditory position lag to the audio object. In addition, when a value of the predetermined flag “objectSourcePositionLagEnabled” included in the bitstream is a second value (e.g., “FALSE”) (e.g., “objectSourcePositionLagEnabled==FALSE”), the audio renderer may not apply the auditory position lag to the audio object. For example, the audio renderer may not apply the auditory position lag to the audio object by skipping modeling with respect to the auditory position lag of the audio object.

According to an embodiment, when the predetermined flag is the first value, the audio renderer may modify a position itemLocation of a render item (e.g., the audio object) from the position 730 to the position 740. For example, the audio renderer may modify the position 730 of the audio object, based on a time delay and a previous position of the audio object included in the movement trajectory 720. For example, the audio renderer may modify the position itemLocation of the render item from the position 730 to the position 740 via a predetermined function (e.g., “itemLocation=PosLag(traj, dist);”). In the present disclosure, for ease of description, the predetermined function to modify the position 730 of the render item may be referred to as an auditory position lag function. According to an embodiment, when the predetermined flag is the second value, the audio renderer may not modify the position 730 of the render item. For example, the audio renderer may not modify the position 730 of the render item by not applying the predetermined function.

The auditory position lag function (e.g., “PosLag( )”) may provide a previous position of the audio object on a movement trajectory traj corresponding to a time delay T required for the sound to travel a distance dist. The audio renderer may determine the previous position of the audio object corresponding to the time delay via the auditory position lag function and may modify the position 730 of the audio object to the position 740 corresponding to the determined previous position.

Referring to FIG. 8, an example of pseudocode 800 of an auditory position lag function to modify a position of a render item is illustrated. The calculation of a render item position “traj.pos(idx)” may be performed as defined in the pseudocode 800 illustrated in FIG. 8. However, the pseudocode 800 illustrated in FIG. 8 is an example for description, and the embodiment is not limited thereto.

FIG. 9 is a diagram illustrating code for rendering a render item according to an embodiment.

Referring to FIG. 9, an example of code 900 representing a render item implemented on software to render an audio object is illustrated. However, the code 900 illustrated in FIG. 9 is an example for description. The embodiment is not limited thereto, and the render item may be implemented in various manners.

According to an embodiment, the code 900 representing the render item may include a flag (e.g., “useDelayedPosition”) to control application of an auditory position and a variable (e.g., “actualDelayedPosition”) indicating an auditory position of the render item. The audio renderer may model an auditory position lag of the render item, based on the flag to control application of the auditory position and the variable indicating the auditory position of the render item that are included in the code 900. The flag to control application of the auditory position may help reduce the complexity of the audio renderer by allowing a VR content creator to selectively apply a sound delay effect to a required audio object. For example, a distance between a visual position of the audio object and a position of a listener or a distance between an auditory position of the audio object and the position of the listener may be selectively used according to the flag.

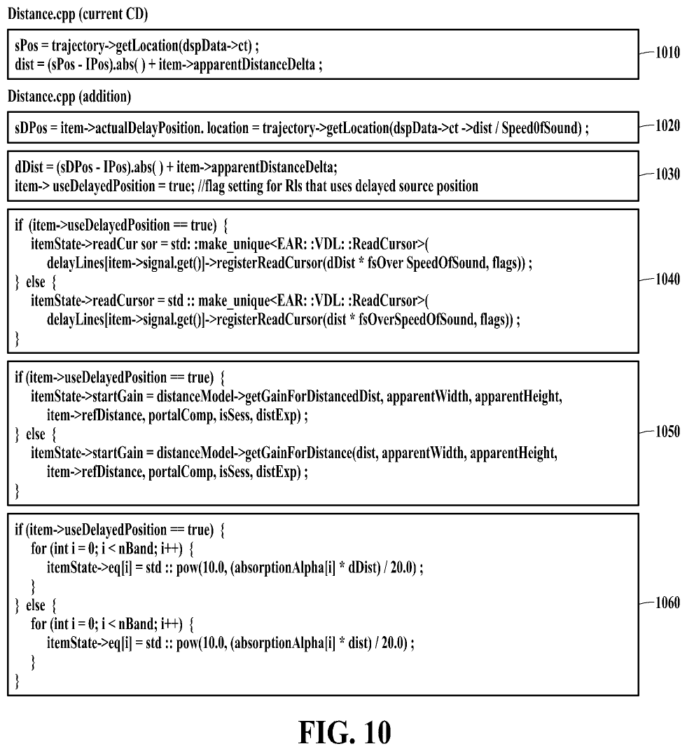

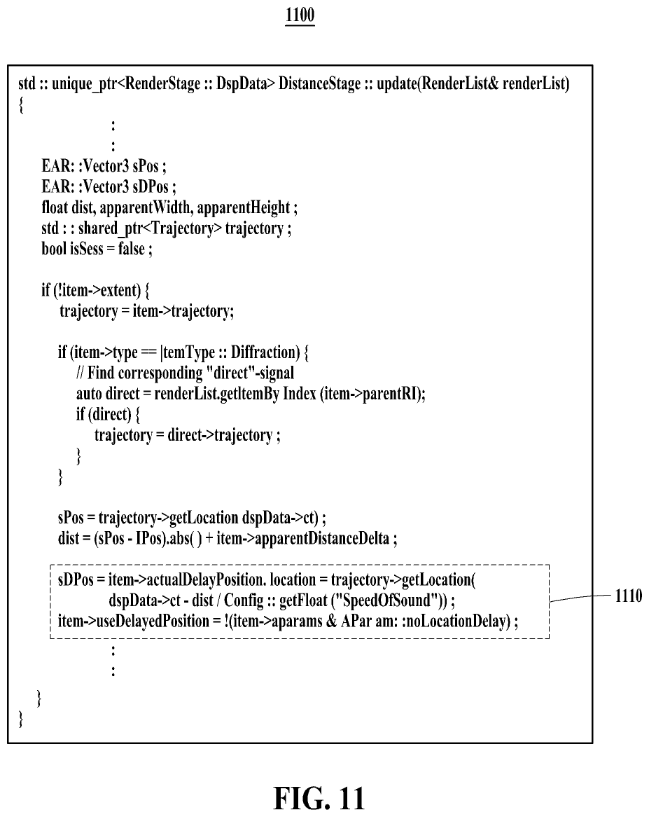

FIGS. 10 and 11 are diagrams illustrating code for modeling an auditory position lag according to an embodiment.

Referring to FIG. 10, an example of code 1010, 1020, 1030, 1040, 1050, and 1060 related to a distance between a render item and a listener is illustrated. However, the code 1010, 1020, 1030, 1040, 1050, and 1060 illustrated in FIG. 10 is an example for description. The embodiment is not limited thereto, and the code may be implemented in various manners.

In the code 1010, an audio renderer may determine a current position of an audio object. In addition, the audio renderer may determine a current distance between the audio object and a listener.

In the code 1020, the audio renderer may determine a time delay taken for sound of a sound source of the audio object to propagate. In addition, the audio renderer may determine a position of the delayed audio object according to the time delay. The audio renderer may modify the position of the audio object, based on the time delay.

In the code 1030, the audio renderer may determine a distance between the modified position of the audio object and the listener.

In the code 1040, the audio renderer may apply a Doppler effect for the audio object to the sound source at the modified position of the audio object. The audio renderer may determine a cursor position for the distance of the delayed audio object for the Doppler effect.

In the code 1050, the audio renderer may determine an attenuation gain for the audio object at the modified position of the audio object. The audio renderer may apply the determined attenuation gain to the sound source of the audio object.

In the code 1060, the audio renderer may determine a medium absorption gain for the audio object at the modified position of the audio object. The audio renderer may determine a medium absorption gain for each frequency band. The audio renderer may apply the determined medium absorption gain to the sound source of the audio object.

Referring to FIG. 11, code 1100 regarding a distance between a render item and a listener may include code 1110 for calculating values for a delayed sound source.

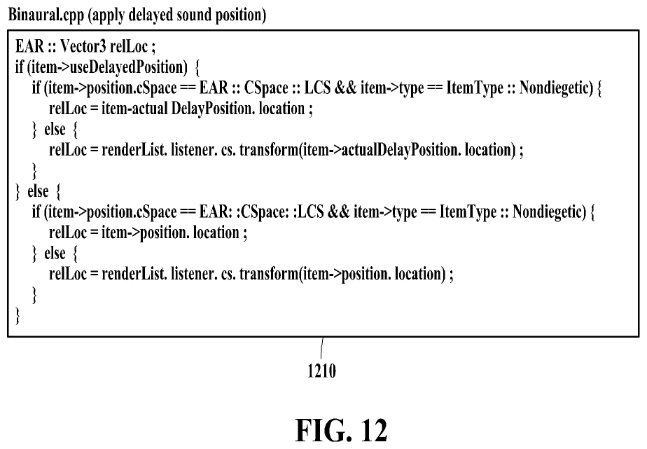

FIG. 12 is a diagram illustrating code for rendering a sound source according to an embodiment.

Referring to FIG. 12, an example of code 1210 to render an audio object at a modified position of the audio object is illustrated. According to a predetermined flag for the audio object, the audio renderer may determine whether to apply an auditory position lag to the audio object and may render a sound source and the audio object at the modified position. The listener may hear sound of the sound source from the auditory position (the modified position) instead of a visual position of the audio object, according to the predetermined flag.

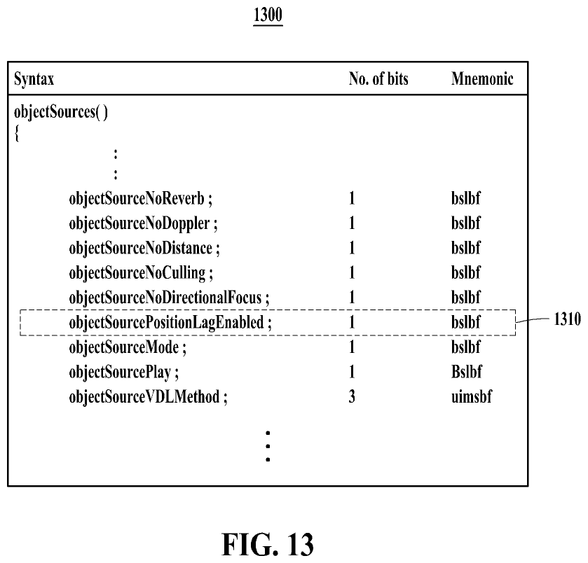

FIGS. 13 to 15 are diagrams illustrating syntaxes and flags according to an embodiment. Syntaxes illustrated in FIGS. 13 to 15 may be different from each other. Flags illustrated in FIGS. 13 to 15 are examples for description. However, the embodiment is not limited thereto, and the syntax may include other flags or some flags may be omitted from the syntax.

Referring to FIG. 13, a syntax 1300 for an audio object may include a flag 1310 (e.g., “objectSourcePositionLagEnabled”) that determines whether to apply an auditory position lag to the audio object. The syntax 1300 may be related to an object source. The flag 1310 may indicate whether an auditory position lag that occurs due to modeling a propagation delay of sound transmitted to a listener is applied to the audio object. For example, the flag 1310 may indicate that, for an audio object that moves quickly in the distance, the auditory position lag is not applied to the audio object. In an embodiment, the audio renderer may skip modeling for an auditory position lag of an audio object that is apart from the listener by a predetermined distance or more. The flag 1310 may not apply to an audio object related to a three-dimensional (3D) extended sound source.

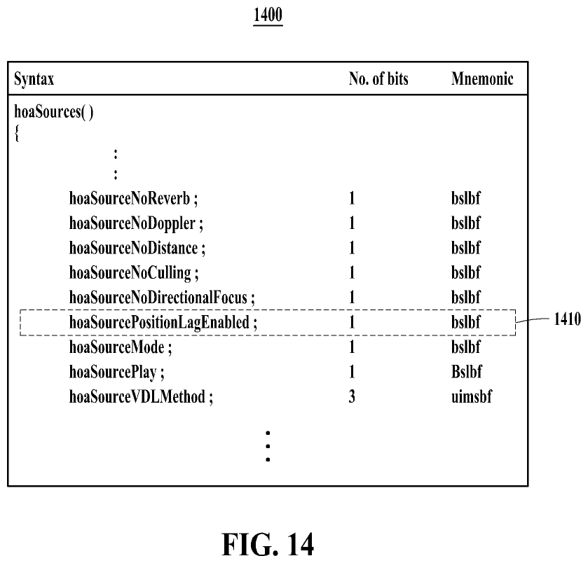

Referring to FIG. 14, a syntax 1400 for an audio object may include a flag 1410 (e.g., “hoaSourcePositionLagEnabled”) that determines whether to apply an auditory position lag to the audio object. The syntax 1400 may be related to an HOA source.

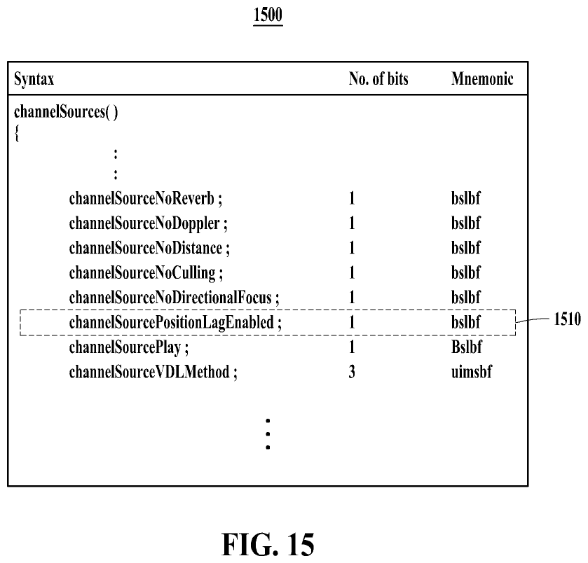

Referring to FIG. 15, a syntax 1500 for an audio object may include a flag 1510 (e.g., “channelSourcePositionLagEnabled”) that determines whether to apply an auditory position lag to the audio object. The syntax 1500 may be related to a channel source.

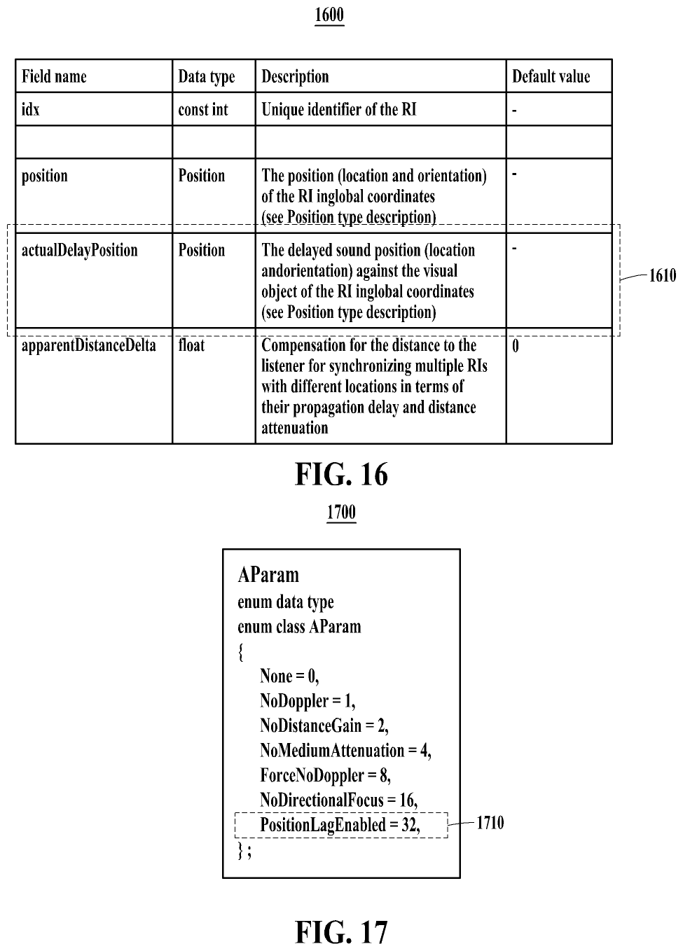

FIG. 16 is a diagram illustrating metadata on a render item according to an embodiment.

Referring to FIG. 16, an example of metadata fields 1600 for a render item is illustrated. The metadata fields 1600 may include a field on a current position of an audio object and a field 1610 (e.g., “actualDelayPosition”) on a modified position. The field 1610 may indicate a position (including a direction) of sound that is delayed with respect to a visual object of a render item in global coordinates. In addition, the metadata fields 1600 may further include a field regarding compensation for a distance to a listener to synchronize a plurality of render items at different positions in terms of propagation delay and distance attenuation.

FIG. 17 is a diagram illustrating a data structure with respect to a render item according to an embodiment.

Referring to FIG. 17, an example of data 1700 representing a render item is illustrated. The data 1700 may include a flag 1710 (e.g., “PositionLagEnabled”) indicating an auditory position lag. The audio renderer may render a delay of a sound source of an audio object, based on an auditory position of the sound source instead of a visual position, according to the flag 1710 in a spatializer.

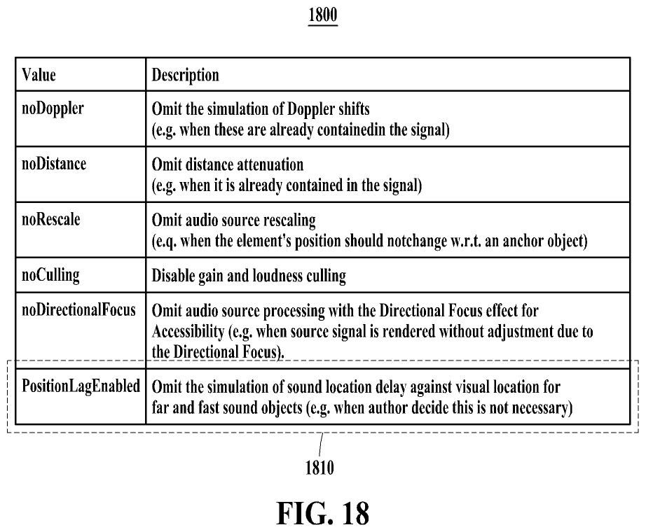

FIG. 18 is a diagram illustrating parameters according to an embodiment.

Referring to FIG. 18, an example of parameters 1800 for an audio object is illustrated. The parameters 1800 may include a parameter 1810 (e.g., “PositionLagEnabled”) about whether to skip modeling an auditory position lag.

FIG. 19 is a block diagram of an audio renderer according to an embodiment.

Referring to FIG. 19, an audio renderer 1900 may include a processor 1910. The processor 1910 may include at least one processor. In addition, the audio renderer 1900 may further include a memory 1920.

The memory 1920 may store instructions (or programs) executable by the processor 1910. For example, the instructions include instructions for performing the operation of the processor 1910 and/or an operation of each component of the processor 1910.

The processor 1910 may be a device for executing instructions or programs or controlling the audio renderer 1900, and may include, for example, various processors, such as a central processing unit (CPU) or a graphics processing unit (GPU). The processor 1910 may determine a distance between a position of an audio object and a listener. Based on the distance, the processor 1910 may determine a time delay required for sound of the audio object to cover the distance. The processor 1910 may modify a position of the audio object, based on the time delay. The processor 1910 may model an auditory position lag of the audio object, based on the modified position of the audio object.

The processor 1910 may modify the position of the audio object, based on the time delay and a previous position of the audio object. The processor 1910 may determine whether to apply the auditory position lag to the audio object, according to a predetermined flag for the audio object. The processor 1910 may render a sound source of the audio object at the modified position of the audio object, according to the auditory position lag. The processor 1910 may determine a distance gain and a medium absorption gain according to the modified position of the audio object, may determine a Doppler effect according to a change in the distance, and may render the sound source of the audio object, based on the distance gain, the medium absorption gain, and the Doppler effect. The processor 1910 may skip modeling for the auditory position lag of the audio object that is apart from the listener by a predetermined distance or more. The processor 1910 may determine a time delay by dividing the distance by the speed of the audio object.

The processor 1910 may determine a distance between a visual position of the audio object and the listener. Based on the distance, the processor 1910 may determine a time delay required for sound of the audio object to cover the distance. The processor 1910 may determine an auditory position of the audio object, based on the visual position and the time delay. The processor 1910 may render the sound source of the audio object, based on the auditory position.

The processor 1910 may determine the auditory position of the audio object, based on the time delay and a previous position of the audio object. The processor 1910 may determine whether to render the sound source of the audio object, according to a predetermined flag for the audio object. The processor 1910 may determine a distance gain and a medium absorption gain according to the auditory position, may determine a Doppler effect according to a change in the distance, and may render the sound source of the audio object, based on the distance gain, the medium absorption gain, and the Doppler effect. The processor 1910 may skip modeling of the sound source of the audio object that is apart from the listener by a predetermined distance or more. The processor 1910 may determine a time delay by dividing the distance by the speed of the audio object.

In addition, the audio renderer 1900 may process the operations described above.

The embodiments described herein may be implemented using a hardware component, a software component and/or a combination thereof. A processing device may be implemented using one or more general-purpose or special-purpose computers, such as, for example, a processor, a controller and an arithmetic logic unit (ALU), a digital signal processor (DSP), a microcomputer, an FPGA, a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be stored in any type of machine, component, physical or virtual equipment, or computer storage medium or device capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter.

The above-described hardware devices may be configured to act as one or more software modules in order to perform the operations of the above-described examples, or vice versa.

As described above, although the embodiments have been described with reference to the limited drawings, a person skilled in the art may apply various technical modifications and variations based thereon. For example, suitable results may be achieved if the described techniques are performed in a different order and/or if components in a described system, architecture, device, or circuit are combined in a different manner and/or replaced or supplemented by other components or their equivalents.

Accordingly, other implementations are within the scope of the following claims.

What is claimed is:

1. A method of operating an audio renderer, the method comprising:
determining a distance between a position of an audio object and a listener;
determining a time delay required for sound of the audio object to cover the distance, based on the distance;
modifying the position of the audio object based on the time delay; and
modeling an auditory position lag of the audio object based on the modified position of the audio object.

2. The method of claim 1, wherein the modifying of the position of the audio object comprises modifying the position of the audio object based on the time delay and a previous position of the audio object.

3. The method of claim 1, wherein the modeling of the auditory position lag comprises determining whether to apply the auditory position lag to the audio object, according to a predetermined flag for the audio object.

4. The method of claim 1, wherein the modeling of the auditory position lag comprises rendering a sound source of the audio object at the modified position of the audio object, according to the auditory position lag.

5. The method of claim 1, wherein the modeling of the auditory position lag comprises:
determining a distance gain and a medium absorption gain according to the modified position of the audio object and determining a Doppler effect according to a change in the distance; and
rendering a sound source of the audio object, based on the distance gain, the medium absorption gain, and the Doppler effect.

6. The method of claim 1, wherein the modeling of the auditory position lag comprises skipping modeling for the auditory position lag of the audio object that is apart from the listener by a predetermined distance or more.

7. The method of claim 1, wherein the determining of the time delay comprises determining the time delay by dividing the distance by a speed of the audio object.

8. A method of operating an audio renderer, the method comprising:
determining a distance between a visual position of an audio object and a listener;
determining a time delay required for sound of the audio object to cover the distance, based on the distance;
determining an auditory position of the audio object, based on the visual position and the time delay; and
rendering a sound source of the audio object based on the auditory position.

9. The method of claim 8, wherein the determining of the auditory position of the audio object comprises determining the auditory position of the audio object, based on the time delay and a previous position of the audio object.

10. The method of claim 8, wherein the rendering of the sound source of the audio object comprises determining whether to render the sound source of the audio object, according to a predetermined flag for the audio object.

11. The method of claim 8, wherein the rendering of the sound source of the audio object comprises:
determining a distance gain and a medium absorption gain according to the auditory position and determining a Doppler effect according to a change in the distance; and
rendering the sound source of the audio object, based on the distance gain, the medium absorption gain, and the Doppler effect.

12. The method of claim 8, wherein the rendering of the sound source of the audio object comprises skipping modeling the sound source of the audio object that is apart from the listener by a predetermined distance or more.

13. The method of claim 8, wherein the determining of the time delay comprises determining the time delay by dividing the distance by a speed of the audio object.

14. An audio renderer comprising:
a processor; and
memory storing instructions,
wherein the instructions, when executed by the processor, cause the audio renderer to:
determine a time delay required for sound of an audio object to cover a distance between a position of the audio object and a listener, based on the distance,
determine whether to apply an auditory position lag to the audio object, according to a predetermined flag for the audio object,
modify the position of the audio object based on the time delay, and
model the auditory position lag of the audio object based on the modified position of the audio object,
wherein the predetermined flag included in a syntax for the audio object.

15. The audio renderer of claim 14, wherein the instructions, when executed by the processor, cause the audio renderer to modify the position of the audio object based on the time delay and a previous position of the audio object.

16. The audio renderer of claim 14, wherein the instructions, when executed by the processor, cause the audio renderer to determine the distance between the position of the audio object and the listener.

17. The audio renderer of claim 14, wherein the instructions, when executed by the processor, cause the audio renderer to render a sound source of the audio object at the modified position of the audio object, according to the auditory position lag.

18. The audio renderer of claim 14, wherein the instructions, when executed by the processor, cause the audio renderer to:
determine a distance gain and a medium absorption gain according to the modified position of the audio object and determine a Doppler effect according to a change in the distance, and
render a sound source of the audio object, based on the distance gain, the medium absorption gain, and the Doppler effect.

19. The audio renderer of claim 14, wherein the instructions, when executed by the processor, cause the audio renderer to skip modeling for the auditory position lag of the audio object that is apart from the listener by a predetermined distance or more.

20. The audio renderer of claim 14, wherein the instructions, when executed by the processor, cause the audio renderer to determine the time delay by dividing the distance by a speed of the audio object.
